(19) United States
(12) Patent Application Publication
(10) Pub. No.: US 2008/0022376 A1
(43) Pub. Date: Jan. 24, 2008

(54) SYSTEM AND METHOD FOR HARDWARE ACCESS CONTROL

(75) Inventors: KE KE, Beijing (CN); Jiancheng Liu, Beijing (CN)

Correspondence Address: DICKSTEIN SHAPIRO LLP, 1177 AVENUE OF THE AMERICAS (6TH AVENUE), NEW YORK, NY, 10036-2714, US

(73) Assignee: LENOVO (BEIJING) LIMITED, Beijing (CN)

(21) Appl. No.: 11/767,266

(22) Filed: Jun. 22, 2007

(30) Foreign Application Priority Data
Jun. 23, 2006 (CN) 2006 100 93161.5
Jun. 29, 2006 (CN) 2006 100 94299.7

(51) Int. Cl. H04L 9/32

(52) U.S. Cl. 726/5

(57) ABSTRACT

The present invention provides a system and method for hardware access control comprising a virtual machine system including a client operating system, a virtual machine monitor and a hardware device, the system further comprises: an access control module provided in the virtual machine monitor and configured to send an authorization request via a network after intercepting a device access instruction from the client operating system; and an authorization management server configured to receive the authorization request from the access control module, judge whether the authorization request satisfies a predetermined authorization strategy and feed back a response corresponding to the authorization request to the access control module; wherein the access control module determines whether the client operating system is permitted to access the hardware device based on the feedback from the authorization management server. With the present invention, the access to the hardware device from the client operating system can be effectively controlled, and thus legal data copy can be guaranteed while prohibiting any illegal data copy.

### BACKGROUND OF THE INVENTION

1. Field of the Invention

The present invention relates to computer information protection technology, in particular to a system for computer hardware access control and a method thereof as well as a system for computer hardware access record and a method thereof.

2. Description of the Prior Art

With the expanding application of the computer, users, especially employees in enterprises, store a growing amount of important data in their computers, while for enterprises, unauthorized copy of companies' confidential data can be restrained or recorded.

The existing general-purpose computer as shown in FIG. 1 usually adopts the following solutions in view of the above problem.

1. Physically destroying hardware 300, for example, breaking USB port or dismounting hardware such as floppy drive. Unfortunately, this method imposes a constraint on the normal copy behaviors of users as well as damage on the machine itself.

2. Installing corresponding software for copy restriction in operating system 200, such as Window XP, to provide data copy security mechanism, such as suppressing copy via USB port or copy of floppy drive. Such software blocks illegal copy from users by intercepting their copy behaviors within the operating system, and the users can perform data copy only when they have been authorized (through local password authorization or network authorization).

The above solutions, however, have drawbacks as follows.

1. With respect to installing application software 100 in operating system, the disadvantage is that a user can reinstall the operating system 200 by formatting hard disk while not installing the software for copy restriction so as to avoid suppression on data copy.

2. Only a specific port, such as USB port, can be restricted, and the user can bypass this measure by adding other hardware or ports.

3. The above measures are not transparent to the user, and the user can detect any restriction on data copy.

4. There is no corresponding mechanism to record any copy behavior.

In addition, the existing virtual machine system as shown in FIG. 2 includes a virtual machine monitor 400, while it has no concern on data copy restriction, namely, it doesn't take data security problem into account. Moreover, when data copy restriction by installing software for copy restriction in the operating system 200 is applied to a virtual machine system in the manner for a general-purpose computer, the same problems as in the general-purpose computer also arise.

On the other hand, no recording of data copy has been established in the existing virtual machine system. Therefore, no corresponding records can be retrieved to analyze the occurrence of illegal data copy after it happens, which makes it difficult to establish corresponding mechanism to prevent illegal data copy in a more proper way.

In view of the above problems, there is demand for a better scheme of computer information protection, which can prevent computer information leakage by controlling data copy and further create a record of data copy.

### SUMMARY OF THE INVENTION

The object of the present invention is to provide a system for computer hardware access control.

Another object of the present invention is to provide a method for computer hardware access control.

A system for hardware access control comprises a virtual machine system including a client operating system, a virtual machine monitor and a hardware device, and it further comprises an authorization management server and an access control module located in the virtual machine monitor.

The access control module is configured to send an authorization request to the authorization management server via a network after intercepting a device access instruction from the client operating system and to determine whether the client operating system is permitted to access the hardware device based on a feedback from the authorization management server. The authorization management server is configured to receive the authorization request from the access control module, judge whether the authorization request satisfies a predetermined authorization strategy and feed back a response corresponding to the authorization request to the access control module.

Information carried by the above authorization request includes the name of the virtual machine system, the type of the hardware device to be accessed by the client operating system and the type of the hardware access instruction.

Further, if the information carried by the authorization request doesn't satisfy the predetermined authorization strategy, the authorization management server feeds back to the access control module an authorization request response for rejecting access, and the access control module in turn rejects the access to the hardware device from the client operating system and also feeds back to the client operating system a response for rejecting access simultaneously.

Further, if the information carried by the authorization request satisfies the predetermined authorization strategy, the authorization management server feeds back to the access control module an authorization request response for permitting access, and to the access control module in turn allows the access to the hardware device from the client operating system.

Further, the authorization management server records the authorization request while making judgment on the authorization request. The authorization management server can further record the authorization request response.

A method for hardware access control comprises steps of:

intercepting a request for accessing a hardware device from a client operating system and generating a corresponding authorization request;

judging whether the authorization request satisfies a predetermined authorization strategy and generating a response corresponding to the authorization request;

permitting or rejecting the access to the hardware device from the client operating based on the authorization request response.

In the above method, the authorization request response indicates the client operating system is permitted to access the hardware device if the authorization request satisfies the predetermined authorization strategy, otherwise it indicates the client operating system is rejected to access the hardware device.

Information carried by the above authorization request includes the name of the virtual machine system, the type of the hardware device to be accessed by the client operating system and the type of the hardware access instruction.

In the above method, the authorization request is recoded at the time of judging whether the authorization request satisfies the predetermined authorization strategy, and the authorization request response is further recorded at the time of permitting or rejecting the client operating system to access the hardware device.

The present invention is endowed with the following advantages when compared with the prior art.

Since the access control module is added to the virtual machine system, and the access to the hardware device is authorized based on the predetermined authorization strategy by the authorization management server in the network, the access to the hardware device from the client operating system can be effectively controlled, and thus legal data copy can be guaranteed while prohibiting any illegal data copy.

On the other hand, the authorization management server in the network records the authorization request and its corresponding response while authorizing the hardware access, therefore, the occurrence of illegal data copy can be analyzed with associated records even if any illegal data copy has happened, and a more proper mechanism can be further established to improve the hardware access control.

In addition, with the present invention, multiple modes of access control can be realized for a shared device according to shared control information including predetermined information on access control. Moreover, since the present invention can set up different information on shared mode according to various application scenarios, a device can be shared in a flexible manner, multiple-mode device sharing can be realized, and the demand for different sharing modes in various scenarios can be further fulfilled. This provides a solution to the dilemma with the device-sharing scheme encountered in the process of virtual machine popularization and hence gives a great boost to the popularization and application of virtual machine system. Further, the present invention also has good extendibility since a plurality of sharing modes can be obtained through extension based on the present invention.

### BRIEF DESCRIPTION OF THE DRAWINGS

FIG. 1 is schematic view for the structure of a general-purpose computer;

FIG. 2 is a schematic view for the structure of the existing virtual machine system;

FIG. 3 is a schematic view for the structure of a system for computer hardware access control according to the first embodiment of the present invention;

FIG. 4 is a flowchart of a method for computer hardware access control according to the first embodiment of the present invention;

FIG. 5 is a schematic view for the structure of a virtual machine system according to the second embodiment of the present invention;

FIG. 6 is a flowchart of a method for hardware access control according to the second embodiment of the present invention;

FIG. 7 is a flowchart for setting up access mode information in the second embodiment of the present invention.

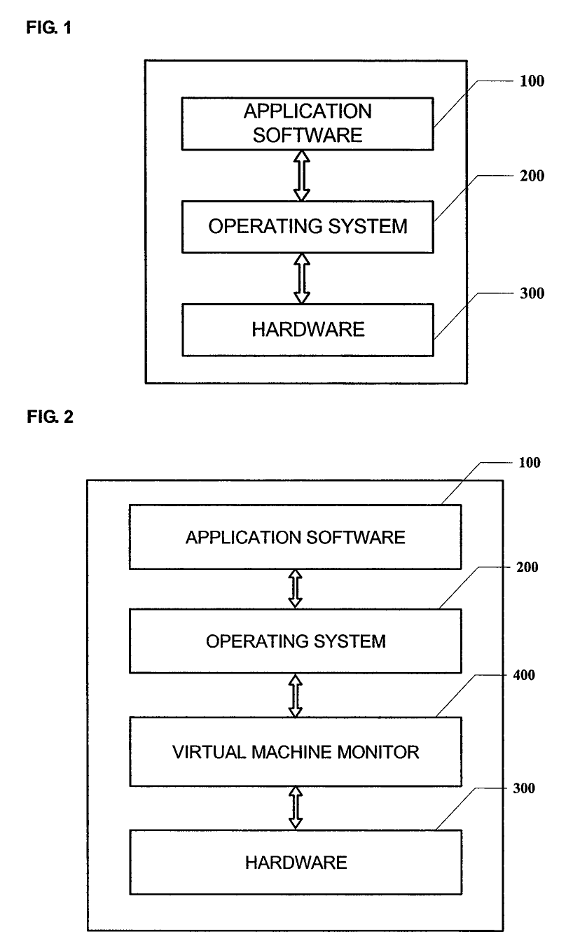

### DETAILED DESCRIPTION OF THE PREFERRED EMBODIMENTS

Hereafter, a detailed explanation will be made to the system and method for computer hardware access control of the present invention in conjunction with the figures.

### First Embodiment

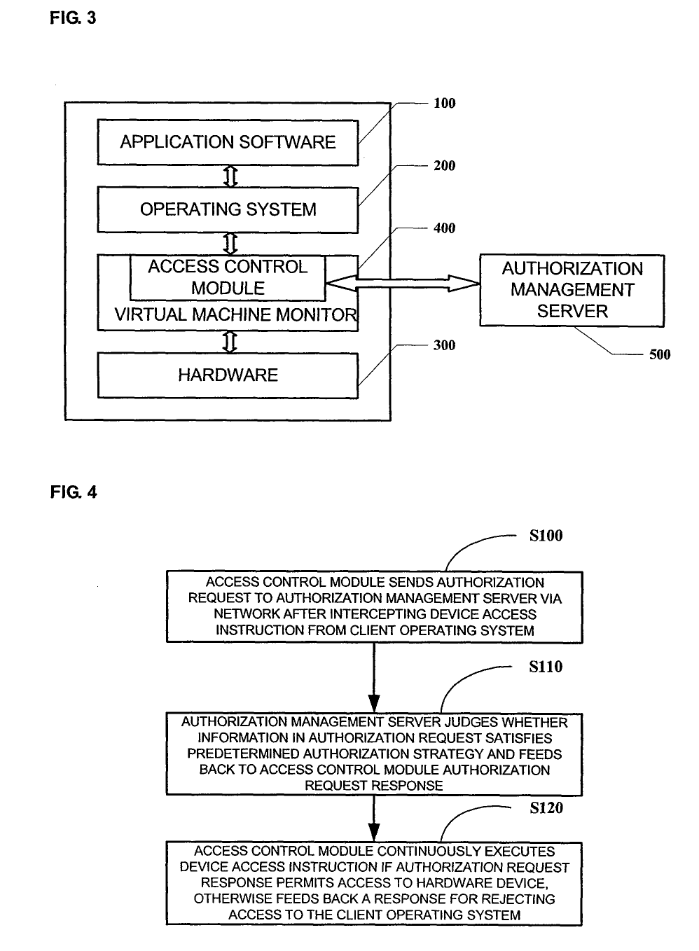

FIG. 3 is a schematic view for the structure of a system for computer hardware access control according to an embodiment of the present invention. As shown in FIG. 3, the system for computer hardware access control according to the present embodiment includes a virtual machine system and an authorization management server 500, which interact with each other with respect to authorization.

The virtual machine system includes a client operating system 200, a virtual machine monitor 400 and a hardware device 300. The difference from the existing virtual machine system is that, in the virtual machine monitor 400 in the present invention, an access control module 410 is added to send an authorization request to the authorization management server 500 via a network after intercepting a device access instruction from the client operating system 200 and to judge whether the device access instruction is permitted to be executed continuously based on a feedback from the authorization management server 500.

Information carried by the authorization request from the access control module 410 to the authorization management server 500 includes the name (or identification) of the virtual machine system, the type of the hardware device 300 (e.g. USB device, CD driver) to be accessed by the client operating system 200 and the type of the hardware access instruction (including read instruction and write instruction).

The authorization management server 500 receives the authorization request from the access control module 410 via the network, judges whether the information in the authorization request satisfies a predetermined authorization strategy and feeds back a response corresponding to the authorization request to the access control module 410. Specifically, it feeds back to the access control module 410 an authorization request response for permitting access if the information in the authorization request satisfies the authorization strategy. Otherwise it feeds back an authorization request response for rejecting access.

The authorization management server 500 further records the authorization request while judging the request and thereby maintains a record on the fact that the client operating system 200 requests to access the hardware device 300.

Obviously, the authorization management server 500 can also record the authorization request responses for permitting access and for rejecting access at the time of recording the authorization request, which enables a better learning on the situation of hardware device access from the client operating system 200.

FIG. 4 is a flowchart of a method for computer hardware access control according to the present embodiment, in which the following steps are included.

In step S100, the access control module 410 sends an authorization request to the authorization management server 500 via the network after intercepting a device access instruction from the client operating system 200.

In step S110, the authorization management server 500 receives the authorization request from the access control module 410 via the network and then judges whether the information in the authorization request satisfies a predetermined authorization strategy (for example, whether some client operating system is permitted to make some type of access to some hardware, and it should be understood that the authorization strategy can be set up correspondingly based on a practical application). It feeds back to the access control module 410 an authorization request response for permitting access if the information in the authorization request satisfies the authorization strategy. Otherwise it feeds back an authorization request response for rejecting access.

In step S120, after receiving the authorization request response from the authorization management server 500, the access control module 410 permits the access to the hardware device 300 from the client operating system 200 and continuously executes the device access instruction if the authorization request response indicates a permission to access the hardware device 300, otherwise it rejects the access to the hardware device 300 from the client operating system 200 and sends a response for rejecting access to the client operating system 200.

In step S110, the authorization management server 500 can further record the authorization request from the access control module 410 after receiving the request.

Also in step S110, the authorization management server 500 can further record the authorization request response while feeding it back to the access control module 410 and establish a mapping relationship between the authorization request response and its corresponding authorization request.

The authorization management server 500 can record more additional content, such as when the authorization request is received, how soon the authorization request response is fed back, etc. Setting can be made as to what content is needed to be recorded depending on different situations.

Since the access control module 410 is added to the virtual machine system in the present embodiment, and the access to the hardware device 300 is authorized based on the predetermined authorization strategy by the authorization management server 500 in the network, the access to the hardware device 300 from the client operating system 200 can be effectively controlled, and thus legal data copy can be guaranteed while prohibiting any illegal data copy.

On the other hand, the authorization management server 500 in the network records the authorization request and its corresponding response while authorizing the hardware access, therefore, the occurrence of illegal data copy can be analyzed with associated records even if any illegal data copy has happened, and a more proper mechanism can be further established to improve the hardware access control.

### Second Embodiment

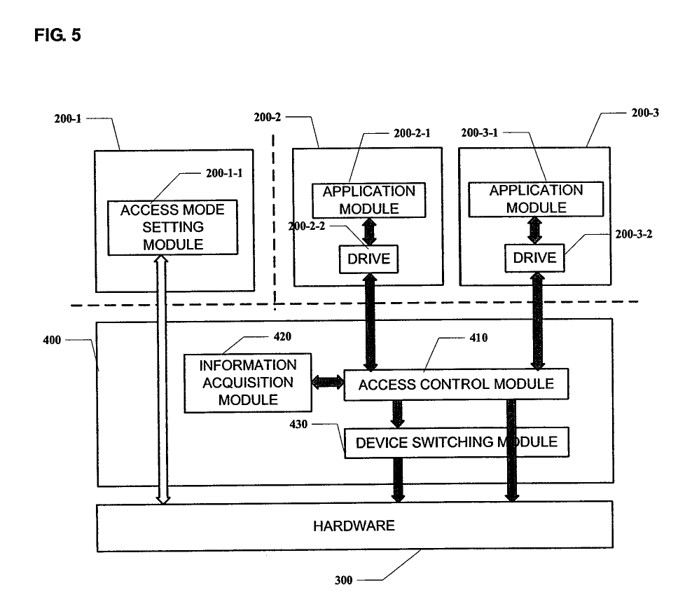

Now the second embodiment of the present invention will be described in detail with reference to FIGS. 5 to 7. The second embodiment differs from the first one in that an information acquisition module 420 and a device switching module 430 are further added into the virtual machine monitor 400, as shown in FIG. 5.

The application scenarios of the virtual machine system become more diversified with the popularization of the virtual machine system, and the requirement for device access mode may also vary in different application scenarios. Table 1 shows various access modes required for a mobile USB (Universal Serial Bus) hard disk in different scenarios.

TABLE 1
Access Mode for USB Hard Disk in Different Scenarios

| Scenario | Access Mode | Specification |
|---|---|---|
| 1 | Fixed | Permit only one client operating system to access at any |
| | Exclusive | time |
| 2 | Foreground | Permit only a foreground client operating system to access |
| | Exclusive | at any time |
| 3 | Single | Permit only one client operating system to access at a |
| | Exclusive | time and permit another client operating system to |
| | | access only after the current client operating system |
| | | relinquishes the right to access voluntarily |
| 4 | Multiple | Permit at most N client operating systems to access at a |
| | Sharing | time, N is greater than one and less than the total |
| | | number of all client operating systems |
| 5 | Overall | Permit all client operating systems to access at a time |
| | Sharing | |

As can be seen from Table 1, various scenarios have different needs for access modes of a hardware device, and apparently, such requirement cannot be fulfilled by the fixed device access scheme.

It is necessary to store the access mode information for the hardware device 300 in a nonvolatile storage medium of the virtual machine system in order to implement multimode access to the hardware device. Since the virtual machine monitor 400 is mainly responsible for resource allocation and management in the virtual machine system, the system performance will be adversely affected if the virtual machine monitor 400 frequently accesses the nonvolatile storage medium during the running of the virtual machine system. Therefore, it is preferable to save in a predetermined region in a memory the access mode information for the hardware device 300 in the nonvolatile storage medium at initialization such that the virtual machine monitor 400 can acquire the access mode information conveniently. The specific process of initialization will be illustrated below.

The above access mode information for the hardware device 300 constitutes part of the access control information, which can also includes device status information and auxiliary control information.

The device status information refers to the current status of a hardware device to be access, such as the operating systems that are currently accessing the device and the number thereof, and can be embodied by a device access list created for each hardware device during the running of the virtual machine system. Some client operating system is added into the device access list for a hardware device when performing access to the hardware device. On the other hand, the client operating system is deleted from the device access list when it stops accessing the hardware device. During the running of the virtual machine system, the device status information can be stored in the predetermined region in the memory together with the access mode information.

The auxiliary control information comprises the status information of the virtual machine system and other setting information, such as access time information, current foreground client operating system, access priority of the foreground client operating system and the like, which are related to the access control for the hardware device 300.

Table 2 shows one example of the content of information that can be contained in the predetermined region in the memory. It will be understood that the stored content can be added or deleted according to actual situations. For example, as to the access mode in which the number of permitted access initiators is limited, such as Single Exclusive mode or Multiple Sharing mode, permitted time for accessing can be included in the stored content, i.e., limitation can be posed on the time for accessing.

TABLE 2
Information Content Stored in Predetermined Region in Memory

| | | | Number of | |
|---|---|---|---|---|
| | | Permitted | Permitted | |
| | | Access | Access | Device Access |
| Device ID | Access Mode | initiator | initiator | List |
| 001 | 1(Fixed Exclusive) | Guest OS1 | | |
| 002 | 2(Foreground | | | |
| | Exclusive) | | | |
| 003 | 3(Single Exclusive) | | | |
| 004 | 4(Multiple Sharing) | | 3 | Guest OS1, |
| | | | | Guest OS2 |
| 005 | 5(Overall Sharing) | | | |

A device ID means identification for distinguishing different hardware devices in a virtual machine system, and information for a corresponding hardware device, such as access mode information, current status information, etc., can be retrieved via a device ID. The set of resource information for each device is unique in a virtual machine system, and the set of interruption number, I/O address, DMA channel and memory address for each hardware device is different from that of any other device. Thus, a device ID can be built for each device with its own set of resource information.

As shown in Table 2, a mapping relationship can be established between access mode information and device ID to facilitate the retrieval of the access mode information for a hardware device according to its device ID. A mapping relationship can also be established between device ID and the storage position of access mode information in the memory. In this way, the access mode information for a hardware device can be acquired at the corresponding storage position that has been obtained directly through the device ID.

FIG. 5 shows a schematic view for the structure of a virtual machine system according to the second embodiment. The virtual machine system of the present embodiment comprises a service operating system 2001-1, client operating systems 200-2 and 200-3, a virtual machine monitor 400 and hardware 300.

The client operating systems 200-2 and 200-3 are the operating systems used by a user, such as Windows XP and the like, and includes application modules 200-2-1 and 200-3-1 as well as drive modules 200-2-2 and 200-3-2. Device access requests sent by the application modules 200-2-1 and 200-3-1 are converted into device access instructions via the drive modules 200-2-2 and 200-3-2, respectively.

The service operating system 200-1 is an operating system providing various services for the client operating systems and includes an access mode setting module 200-1-1 for setting different access mode information based on various application environments.

The virtual machine monitor 400 operates on the hardware, has the right to control system resource, manages the allocation of hardware resource (processor, memory and other devices) in the virtual machine system and comprises an access control module 410, an information acquisition module 420 and a device switching module 430.

The access control module 410 is configured to send a request for acquiring access control information after intercepting a device access instruction from a client operating system and to, based on the acquired access control information, generate a corresponding control command to control the access to a device from the client operating system. If device switching is required, the access control module 410 sends the control command to the device switching module 430, which in turn performs device switch, otherwise, it sends the control command directly to and informs CPU or DMA controller of continuing the execution of the device access instruction.

The information acquisition module 420 is configured to acquire the access control information according to the request sent by the access control module 410 and to sends the acquired access control information to the access control module 410.

The device switching module 430 is configured to switch between devices according to the control command from the access control module 410.

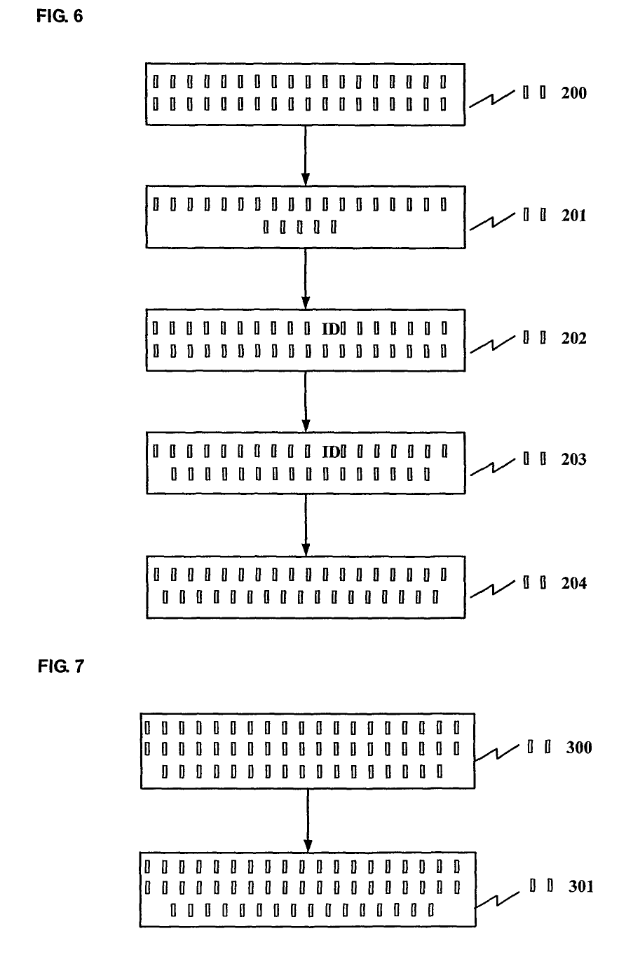

Below is a concrete description on the access control method for hardware device with reference to FIG. 6.

FIG. 6 is a flowchart for the access control method for hardware device of the present invention. As shown in FIG. 6, initialization is first executed at the start of the virtual machine system, in which the stored access mode information for respective hardware devices is read directly from the nonvolatile storage medium (e.g. hard disk, FLASH and the like) and then stored in the predetermined region in the memory (step S200). For example, during the start of the virtual machine system, the stored access mode information for respective hardware devices can be read from the nonvolatile storage medium through an interface which is provided by the virtual machine system for accessing the nonvolatile storage medium, and the obtained access mode information can be stored in the predetermined region in the memory with a memory write instruction.

When the user's operation or the application module 200-2-1 triggers a device access request after the initialization of the virtual machine system, the drive module 200-2-2 converts the device access request into a device access instruction and hands it to CPU or DMA controller.

After receiving the device access instruction from the client operating system, CPU or DMA controller hands the right to control over to the virtual machine monitor 410 such that the virtual machine system is brought into ROOT mode (the running mode in which the virtual machine monitor holds the right to control) out of EON-ROOT mode (the running mode in which the client operating system holds the right to control). As a specific example, CPU can make the virtual machine be switched from NON-ROOT mode to ROOT mode by invoking VM-EXIT command, and in this way, the virtual machine monitor 410 can intercept the device access instruction sent by the client operating system 200-2 (step S210).

After the virtual machine monitor 400 intercepts the device access instruction sent by the client operating system 200-2, the access control module 410 learns the device ID of the hardware device to be access from the set of resource information, which is contained in the device access instruction and includes the port address, interruption number, memory address, DMA channel and the like information for the hardware device, and sends to the information acquisition module 420 a request for acquiring the access control information for the hardware device (step S220).

The information acquisition module 420 obtains the access mode information and the device status information for the hardware device from the predetermined region in the memory according to the device ID and further obtains auxiliary control information from the virtual machine system. For example, the auxiliary control information can be information as to whether a client operating system is at foreground. Since such information is included in the property of each client operating system in the virtual machine system, the current foreground client operating system can be determined by checking the property of each client operating system. The information acquisition module 420 returns the obtained access control information to the access control module 410 after acquiring the information (step S230). Instead of acquired by the information acquisition module 420, the access control information can also be acquired from the predetermined region in the memory and the virtual machine system directly by the access control module 410.

Having obtained the access control information, the access control module 410 determines whether the client operating system 200-2 is permitted to access the hardware device 300 based on the access control information (step S240).

Hereafter, a specific control and judgment process will be explained by example of the above access modes for USB hard disk in Table 1.

1) In the case of the device access mode being fixed exclusive mode, the access control module 410 judges whether the permitted access initiator in the access mode information is consistent with the client operating system which sends the device access instruction, and permits the client operating system to access the hardware device 300 if it is consistent, otherwise rejects the access.

2) In the case of the device access mode being foreground exclusive mode, the access control module 410 judges whether the foreground client operating system in the auxiliary control information is consistent with the client operating system which sends the device access instruction, and permits the client operating system to access the hardware device 300 if it is consistent, otherwise rejects the access.

3) In the case of the device access mode being single exclusive mode, the access control module 410 determines from the current device status the number of the client operating systems accessing the hardware device 300 currently, and permits the access of the client operating system sending the device access instruction if the number is zero, otherwise rejects the access.

4) In the case of the device access mode being multiple sharing mode, the access control module 410 determines from the current device status whether the number of the client operating systems accessing the hardware device 300 currently is less than the maximum number of permitted accesses in the access mode information, and permits the access of the client operating system sending the device access instruction if it is, otherwise rejects the access.

5) In the case of the device access mode being overall sharing mode, the access control module 410 permits directly the access of any the client operating system sending the device access instruction.

When the client operating system 200-2 is permitted to access the hardware device, it is further judged whether there is need for device switching, for example, as for a device in foreground exclusive mode, switching is required if another client operating system is accessing the device at the moment. The access control module 410 then sends a control command to the device switching module 430, which in turn switches the device from the another client operating system to the operating system permitted to access in such a manner as neglecting and abandoning the access instruction or access data issued by the another client operating system, or mapping its access address to any other irrelevant position, or sending a message informing the another client operating system of stopping its access. Meanwhile, the device switching module 430 issues the control command to associated CPU or DMA controller such that they continues to process the device access instruction from the permitted client operating system. So far, the device switching process is completed. If the device switching isn't required, the access control module 410 sends the control command to the associated CPU or DMA controller such that they continues to process the device access instruction from the permitted client operating system.

After the access control module 410 issues the control command, CPU hands the right to operation over to the client operating system and returns its operation result to the drive module 200-2-2 in the client operating system 200-2. For example, CPU can invoke VM-ENTRY command to bring the virtual machine from ROOT mode to NON-ROOT mode, and the drive module 200-2-2 in the client operating system returns the information on the operation result to the upper-layer client operating system after obtaining the information. In addition, the operation result can be returned only in response to an access instruction for which the returning of the operation result is necessary.

The access control described above is only for the purpose of illustration. In fact, other control rules can also be added. For example, as to the access mode in which the number of permitted accesses is limited, such as Single Exclusive mode or Multiple Sharing mode, permitted time for accessing can further be set. When the time for device access is limited in the access mode information, it is required in the virtual machine system that access time for each device being accessed is recorded and such recorded access time is contained in the auxiliary control information acquired by the information acquisition module. Following the acquisition of the access time for the device, the access control module can immediately reject the access from any client operating system which has exceeded the limited access time and then control the access to the device based on the access control information or first judges whether access can be permitted in the current status. If the access to the device is overtime in the case of access being not permitted, the device switching module 430 performs device switching so as to switch the device from the time-exceeding client operating system to another client operating system that issues a device access control instruction.

Furthermore, a priority rule can be added if desired. For example, as to the access mode in which the number of permitted accesses is limited, such as Single Exclusive mode or Multiple Sharing mode, the priority rule can be set such that the device access control can be further performed according to the priority of each client operating system provided in the virtual machine system. The device access list is checked when the device status information indicates that the number of client operating systems currently accessing the device has reached a maximum, and if there is a client operating system with low priority in the list, the device switching module can perform device switching so as to reject the access from the client operating system with relatively low priority while permitting the access from one with relatively high priority. Specifically speaking, the rejection strategy can be to reject the access from a client operating system that has the lowest priority or that has maintained its access for the longest time among all low-priority client operating systems. Such strategy can be set in accordance with the system requirement, and other schemes can also be employed. Base on the idea of the present invention, it is therefore possible to set various access modes and access rules, which endows the present invention with considerable extendibility.

In the systems and methods of the above embodiments, the access to the hardware device can be control based on the access mode set in the virtual machine system. Such mechanism can be readily effected by, during the running of the virtual machine system, saving predetermined access mode information in a predetermined region in the memory and controlling the access to the hardware device based on the access control information including the access mode information.

In addition, FIG. 7 shows the process of a method for setting up access mode information depending on various application scenarios.

As shown in FIG. 7, when the virtual machine system is forced into Root-3 mode in which the service operating system possesses the right to control, the access mode setting module 200-1-1 in the service operating system 200-1 issues a request for reading access mode information. Then, the drive module 200-2-2 converts the request into a device access instruction, and the information acquisition module 420, based on the device access instruction, acquires the access mode information directly from the nonvolatile storage medium (e.g. hard disk, FLASH) and presents it to the user. Besides, the access mode setting module 200-1-1 can also acquires the access mode information directly from the predetermined region in the memory or send a request to the access control module 410, which in turn instructs the information acquisition module to acquire the access mode information stored in the predetermined region in the memory and then returns the acquired device access information to the access mode setting module 200-1-1 (step S300).

Next, the user modifies the access mode information at the service operating system 200-1. Following the confirmation of modifying the information, the access mode setting module 200-1-1 reissues a device access request, updates the access mode information stored in the nonvolatile storage medium with the modified information and simultaneously updates the access mode information stored in the predetermined region in the memory. In addition to a direct update of the access mode information stored in the memory in a common memory access manner, the access mode setting module 200-1-1 sends a request to the access control module 410, which is in turn responsible for the update of the access mode information (step S310).

It should be noted that parameter setting is conduct not only at the service operating system in this embodiment. Alternatively, an access mode setting module can be provided in the client operating system in order to perform parameter setting. The access mode setting module can also be provided in both of the client operating system and the service operating system. When such module is provided in the former, the right to parameter setting at the client operating system can be limited through, for example, identity verification so as to guarantee the security for the system.

The setting of access mode information at the client operating system differs from that at the service operating system in that the parameter setting needs to be conducted when the system runs in NON-ROOT mode, i.e., the mode in which the client operating system possesses the right to control. The specific process are similar to the usual process of reading and writing in the memory and nonvolatile storage medium from the client operating system, and the details thereof will be omitted here.

With the present invention, access control for the hardware device can be realized, various access modes can further be provided depending on different application scenarios so as to implement multimode access to the hardware device and fulfill the need for diversified access modes in a plurality of scenarios, and thereby facilitating the popularization and application of the virtual machine system. Besides, it is based on the present invention to add access modes and stipulate corresponding access rules as actually demanded, so the system of the present invention has excellent extendibility.

It should be noted that, although two client operating systems 200-2 and 200-3 are shown in FIG. 5, this is only for the purpose of concise explanation, and the virtual machine system of the present invention can actually contain more than two client operating systems if necessary. Any change in this respect has no essential effect on the implementation of the present invention. Moreover, though the description presents several embodiments by example of the virtual machine system Xen, the present invention is not limited thereto, and the concept of the present invention can be applied to virtual machine systems represented by Vm Ware or Xen, their variations and other structures and types of virtual machine systems.

The above discloses only the preferred embodiments of the present invention and has no intention to limit the scope of the present invention. Any variation or substitution that can be readily envisaged by those skilled in the art should be encompassed in the scope of the invention, which is therefore defined by the appended claims.

What is claimed is:

1. A system for hardware access control comprising a virtual machine system including a client operating system, a virtual machine monitor and a hardware device, the system further comprises:
an access control module provided in the virtual machine monitor and configured to send an authorization request via a network after intercepting a device access instruction from the client operating system; and
an authorization management server configured to receive the authorization request from the access control module, judge whether the authorization request satisfies a predetermined authorization strategy and feed back a response corresponding to the authorization request to the access control module,
wherein the access control module determines whether the client operating system is permitted to access the hardware device based on the feedback from the authorization management server.

2. The system of claim 1, wherein the authorization request carries information including the name of the virtual machine system, the type of the hardware device to be accessed by the client operating system and the type of the hardware access instruction.

3. The system of claim 2, wherein if the information carried by the authorization request doesn't satisfy the predetermined authorization strategy, the authorization management server feeds back to the access control module an authorization request response for rejecting access, and the access control module in turn rejects the access to the hardware device from the client operating system.

4. The system of claim 3, wherein the access control module further feeds back to the client operating system a response for rejecting access at the time of rejecting the access from the client operating system.

5. The system of claim 2, wherein if the information carried by the authorization request satisfies the predetermined authorization strategy, the authorization management server feeds back to the access control module an authorization request response for permitting access, and to the access control module in turn allows the access to the hardware device from the client operating system.

6. The system of claim 1, wherein the authorization management server records the authorization request while making judgment on the authorization request.

7. The system of claim 6, wherein the authorization management server further records the authorization request response.

8. The system of claim 1, wherein access mode information for each hardware device is stored in nonvolatile storage medium of the virtual machine system, said virtual machine monitor further includes an information acquisition module, and
said access control module sends to the information acquisition module a request for acquiring access control information for the device after the virtual machine monitor intercepts the device access instruction from the client operating system;
said information acquisition module acquires the access control information including access mode information based on the request sent by the access control module and sends the acquired information to the access control module; and
based on the obtained access control information, said access control module generates a corresponding control command to control the access to the device from the client operating system.

9. The system of claim 8, wherein said virtual machine monitor further includes an device switching module for performing device switching based on the control command by the access control module.

10. The system of claim 8, wherein said virtual machine system further includes an access mode setting module for setting access mode information correspondingly based on different application environments.

11. The system of claim 10, wherein said access mode setting module is provided in a service operating system and/or the client operating system.

12. The system of claim 8, wherein the access mode information for the hardware device stored in the nonvolatile storage medium is also saved in a predetermined region in a memory, and said information acquisition module acquires the access mode information from the predetermined region in the memory.

13. The system of claim 8, wherein said access control information further includes device status information and auxiliary control information.

14. The system of claim 13, wherein said device status information is stored in the predetermined region in the memory.

15. A method for hardware access control comprising steps of:
intercepting a request for accessing a hardware device from a client operating system and generating a corresponding authorization request;
judging whether the authorization request satisfies a predetermined authorization strategy and generating a response corresponding to the authorization request; and
permitting or rejecting the access to the hardware device from the client operating based on the authorization request response.

16. The method of claim 15, wherein the authorization request response indicates the client operating system is permitted to access the hardware device if the authorization request satisfies the predetermined authorization strategy, otherwise it indicates the client operating system is rejected to access the hardware device.

17. The method of claim 15, wherein the authorization request carries information including the name of the virtual machine system, the type of the hardware device to be accessed by the client operating system and the type of the hardware access instruction.

18. The method of claim 15, wherein the authorization request is recoded at the time of judging whether the authorization request satisfies the predetermined authorization strategy.

19. The method of claim 18, wherein the authorization request response is recorded at the time of permitting or rejecting the client operating system to access the hardware device.

20. The method of claim 15, further comprising:
storing in a predetermined region in a memory predetermined device access information stored in nonvolatile storage medium.

21. The method of claim 20, further comprising:
an access control module obtains a device ID and sends to an information acquisition module a request for acquiring access control information for the device;
the information acquisition module acquires the access control information including predetermined device-sharing mode information based on the device ID and sends the acquired information to the access control module; and
based on the access control information, the access control module decides whether the client operating system is permitted to access the device.

22. The method of claim 21, wherein said step of the access control module deciding whether the client operating system is permitted to access the device based on the access control information includes:
if the device access mode is overall sharing mode, the access control module permits directly the access from the client operating system sending the device access instruction; or
if the number of client operating systems accessing the device is limited in the device access mode, the access control module judges whether the number of the client operating systems currently accessing the device is less than the defined number and permits the access from the client operating system sending the device access instruction if the answer is yes, otherwise rejects said access, or rejects the access from a client operating system having a priority lower than that of the client operating system sending the device access instruction and permits the access from the latter, or rejects the access from a client operating system which exceeds the time for access and permits the access from the client operating system sending the device access instruction; or
if there is limitation on any client operating system accessing the device in the device access mode, the access control module judges whether the client operating system sending the device access instruction is consistent with the client operating system permitted to access and permits the access from the former if it is consistent, otherwise rejects the access from it.

23. The method of claim 22, wherein said predetermined access mode information is set through steps of:
acquiring the access mode information from the nonvolatile storage medium or the predetermined region in the memory in which the access mode information is stored; and
after modifying the access mode information, updating the access mode information stored in the nonvolatile storage medium and the predetermined region in the memory with the modified access mode information.
